(19) United States
(12) Patent Application Publication
(10) Pub. No.: US 2011/0218133 A1
(43) Pub. Date: Sep. 8, 2011

(54) Two-part liquid cleaner system

(76) Inventors: Scott W. Garner, Ballwin, MO (US); Joseph Raible, St. Louis, MO (US)

(21) Appl. No.: 12/660,796

(22) Filed: Mar. 4, 2010

(51) Int. Cl. C11D 3/00

(52) U.S. Cl. 510/109

(57) ABSTRACT

A liquid two-part HVAC coil cleaning system wherein the chemical ingredients of the system are separated into two groups of chemical components such that the first group of chemical components is placed in a first container and the second group of chemical components is placed within a second container, wherein the selection of the chemical components of the two groups of chemical components allows the packaging and shipping of both groups of chemical components as a non-hazardous material, wherein a minimum amount of water is included in the cleaning system, and wherein all the chemical components from both containers are combined with additional water at a job site to prepare a full strength liquid HVAC coil cleaner.

### CROSS REFERENCE TO RELATED APPLICATIONS

Not applicable.

### STATEMENT REGARDING FEDERALLY SPONSORED RESEARCH

Not Applicable.

### BACKGROUND OF THE INVENTION

This invention relates to a liquid cleaner generally used in the cleaning and removing of debris and contamination from evaporation coils and condensation coils used within heating ventilating and air conditioning (HVAC) systems.

In general, HVAC systems generate cool air by condensing a refrigerant and then allowing the refrigerant to evaporate under controlled conditions. To accomplish this, the HVAC system has a compressor unit that compresses the refrigerant to a set pressure. The compressed refrigerant is then transferred within the HVAC system through the use of various types of high pressure and low pressure refrigerant lines.

One such transfer includes the movement of the pressurized refrigerant to an evaporator coil. An expansion valve is positioned within the refrigerant lines just before the pressurized refrigerant enters the evaporation coil and allows the compressed refrigerant to become unpressurized as it enters the evaporator coil. As suggested by the laws of thermodynamics, this evaporation process significantly reduces the temperature of the refrigerant as it travels throughout the evaporator coil. Air circulation devices such as fans and blowers push air through the evaporator coil and the cooler air is distributed throughout an area to be cooled to reduce the ambient temperature within that area.

During the process of pressurizing the refrigerant, the temperature of the refrigerant increases significantly as the refrigerant is pressurized by a compressor unit. If the pressurized refrigerant is extremely warm as it enters the expansion valve and evaporation coil, the efficiency of the HVAC system is severely reduced. Therefore, the HVAC system reduces the temperature of the pressurized refrigerant just after the refrigerant is pressurized by the compressor by passing the newly pressurized refrigerant through a condenser coil. A second fan or blower pushes ambient air through the condenser coil to transfer some of the heat of the refrigerant into the ambient air. The ambient air then exits the condenser coil area after being replaced by additional fresh air by the blower or fan.

In the case of both the evaporator coil and the condenser coil, the design of the coils include the use of thin wall tubing that is surrounding by a set of thin vane-like appendages mounted radially around the tubes. The thin vanes act in the matter of a heat transfer device that allows air being blown across the tubing and the vanes to allow the coil to transfer heat either from or into the refrigerant.

It is very important that the surfaces of the coil components be kept as clean as possible. Clean surfaces increase the efficiency of the coils by allowing the refrigerant to more readily transfer heat to the air being passed through the coil by the fan or blower. Additionally, dirty tubing and vanes within the coils can act as insulators to prevent rapid heat transfer. Any reduction of the ability of either the evaporator coil or the condenser coil to transfer heat will severely reduce the efficiency of the coil.

Because the coils must be kept as clean as possible, various types of coil cleaners have been devised. Because the thin-walled tubing and the vanes of the HVAC coils are delicate and can be easily damaged by using a mechanical cleaning process such as brushing the coils, one type of coil cleaner is a liquid cleaner that is shipped in a single container and is ready-to-use in cleaning the coils. It has been found that certain types of chemicals work better in lifting and removing the contaminants that have become lodged within the vanes and tubing of the coils. In most cases the chemical cleaners for HVAC coils include some type of either alkaline-based or acidic-based chemical mixture.

Most HVAC coil cleaners include about 30% to about 50% active chemical ingredients and about 50% to about 70% of water. Thus, when such cleaners are shipped, a substantial amount of the shipping weight resides in the weight of the large amount of water within the cleaner. The high percentage of water also increases the volume of each container used for storage of the HVAC coil cleaner in warehouses.

Additionally, shipping liquid HVAC coil cleaners that contain such strong acids or alkaline chemicals can also be very problematic. Rules and regulations of the Federal Department of Transportation (DOT) control the shipping methods to be used for shipping items that contain hazardous chemicals such as strong acids and alkaline components. Thus, in the case of liquid HVAC coil cleaners, the significant level of acids and alkaline components found in those cleaners normally require those HVAC coil cleaners to be shipped as hazardous material. The costs of packaging, labeling, and shipping of hazardous materials add significant costs to the HVAC coil cleaners.

It is noted that under the DOT rules, the necessity of shipping the liquid HVAC cleaner as a hazardous material can depend upon the type of chemicals in the package and/or the amount of certain chemicals in the package. In some situations, some chemicals are so hazardous that any amount of that chemical requires shipping the package as a hazardous material. In other situations, the DOT will allow non-hazardous shipment of some relatively hazardous materials if the amount of the hazardous material shipped does not exceed a certain amount as determined by the DOT

There have been many attempts to manufacture liquid HVAC coil cleaners that are in concentrated form and that do not include such high volumes of water or quantities of dangerous chemicals. After such concentrated HVAC coil cleaners reach the job site, the end user then adds the necessary proportion of water to prepare the ready-to-use liquid cleaner. However, the attempts by others to manufacture and ship concentrated versions of liquid HVAC coil cleaners have revealed a number of drawbacks. It was found that the chemical combinations used by others led to generally inferior cleaners resulting from a lack of chemically compatible components.

An alternative to manufacturing concentrated forms of liquid HVAC coil cleaners is to manufacture HVAC coil cleaners in powder form. In that case, various components of the HVAC coil cleaner are shipped in powder form and then mixed with water at the job site to prepare the liquid full strength ready-to-use coil cleaner. In fact, the present inventors are identified in U.S. Pat. No. 7,338,564, incorporated by reference into the present application as if fully stated herein, and that patent discloses a powdered evaporator coil cleaner. The present inventors are also identified in published application US 2007/0281876, of U.S. patent application Ser. No. 11/756,495, that is also incorporated by reference into the present application as if fully stated herein. That published application also identifies embodiments of powdered forms of HVAC cleaners.

While powdered HVAC coil cleaners are good for use in certain applications for cleaning HVAC coils, there are some issues associated with powdered HVAC coil cleaners that may arise in certain other applications. For example, in some cases there may be solubility problems in the mixing of the various powdered elements. If the sequence of mixing the elements is not specifically followed, or the amount or agitation used in the mixing of the powdered elements with water is not exactly correct, the solution will not result in a liquid cleaner that has the correct efficacy, density, homogeneity, viscosity, or usability. It has also been found that the price of powdered formats is notably higher than the liquid format HVAC coil cleaners. Finally, it is noted that it takes a longer time to properly mix powdered chemical components with water at the job site—an inconvenience that is particularly frustrating to HVAC contractors.

Therefore, a successful form of a two-part HVAC coil cleaners is needed that would have as little water as possible, that would not need to be packaged or shipped as a hazardous material, but would still be in a liquid format that can be made ready-to-use by contractors without significant mixing time and without fear of having solubility problems with the HVAC coil cleaner.

Attempts to make highly concentrated cleaners have met with limited success due to chemical incompatibilities at high concentrations. The resulting formulations had poor viscosity or exhibited poor cleaning profiles. Dividing the concentrated cleaner into two chambers allows one to separate chemically incompatible components from one another. This type of two chamber design would allow one proficient in the art to use all of the chemicals commonly utilized, provided that care is taken to use only compatible components in each chamber. Having access to all chemicals commonly used in the art makes it possible to fashion a cleaner that would be at least as effective and stable as those already produced in less concentrated form, and allow for the development of more effective cleaners as more efficient components, that are still incompatible at high concentration, become available.

### SUMMARY OF THE INVENTION

As noted above, the general chemical components and percentages of chemical composition for a one part liquid HVAC coil cleaner are well-known in the art. However, those elements are only known as they relate to a one-part standard full strength or one-part concentrated liquid HVAC coil cleaner sold as a single liquid component in a single container. In the full strength versions, this includes all additional water needed to make the liquid HVAC coil cleaner ready for use when opened at a job site, and the need to ship the cleaner as a hazardous material.

As suggested above, the many attempts to formulate a concentrated liquid HVAC coil cleaner that did not contain significant volumes of water were unsuccessful. Some attempts revealed problems associated with getting enough surfactant into the concentrate. In yet other attempts, there were problems associated with getting enough foam stabilizer or chelate into the concentrate. In general, these attempts also did not preclude the need to ship the end product as a hazardous material because of the type and amount of chemicals used in the concentrated cleaner. Many of these problems often resulted in solubility problems.

In contrast, the embodiments of the present include a liquid two-part HVAC coil cleaner that can be shipped with significantly reduced amounts of water and without being shipped as a hazardous material under current DOT rules and regulations. Each of the two-parts contains a unique combination of ingredients in certain quantities that were only discovered after extensive research and development by the inventors. The testing and research was conducted to determine which two-part chemical combinations were capable of providing the best cleaning performance without certain solubility problems, while at the same time diminishing the compatibility problems found in current highly concentrated cleaning compositions. The additional goal was to generate a liquid two-part HVAC coil cleaner system that would have limited amounts of water until the water was added to the two-part liquid cleaner at the job site.

During the research, about 50 surfactants were tested to determine which was best for the two-part system. A large number of chemical combinations were tried for each of the two parts.

The extensive research and development phase was found to be required because the combination of chemicals that would normally be used by those of skill in the art did not provide the proper combination and percentage of chemical composition needed to result in a stable and soluble concentrate for use in a liquid two-part HVAC coil cleaner. Normal chemical combinations that were suggested in the prior art and that were determinable though standard chemical analysis failed to achieve the results necessary for an efficient two-part liquid HVAC coil cleaner. Eventually, the chemical combinations and percentages of composition in the embodiments of the present invention were not found through only theoretical analysis, but were finally discovered through empirical analysis of a large number of experimental combinations. As such, the two-part liquid HVAC coil cleaner as described in the various embodiments of the present invention were not predictable or suggested by prior combinations and were, in fact, an unexpected combination that, for reasons known and unknown, provide the necessary solubility, compatibility, and stability needed to function as a two-part liquid HVAC coil cleaner system.

Therefore, in accordance with the present invention, a two-part liquid cleaner system is disclosed wherein the liquid cleaner includes two containers of unique combinations and quantities of chemical components that are shipped in a container having two segregated compartments that contain each of the two parts of the cleaner, and wherein the combination of all chemical components includes as little water as possible. After shipment, the two-part liquid HVAC coil cleaner system allows the two parts to be combined with additional water at a job site to result in an effective cleaner for use in the cleaning of the condensation and evaporation coils of HVAC systems.

The various embodiments of the present invention offer a number of potential advantages. By not including excessive water in some embodiments, no unnecessary shipping costs are incurred by shipping water that can be added later after shipment of the cleaner. Additionally, the smaller size of the product as shipped reduces the warehouse and storage space needed. It is also noted that the unique combinations of chemical components of the various embodiments preclude the need to package, label, or ship the liquid HVAC coil cleaner system as a hazardous material.

### DESCRIPTION OF THE DRAWINGS

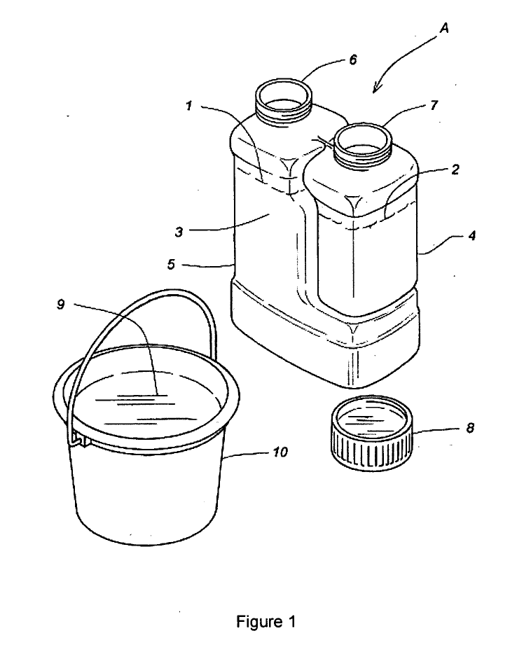

In the accompanying drawings which form part of the specification, FIG. 1 shows a front perspective view of one embodiment of the present invention.

Corresponding reference numerals indicate corresponding steps or parts throughout the several figures of the drawings.

While one embodiment of the present invention is illustrated in the above referenced drawings and in the following description, it is understood that the embodiments shown are merely exemplary of preferred embodiments and offered for the purpose of illustration only. It is understood that various changes in construction may be resorted to in the course of manufacture in order that the present invention may be utilized to the best advantage according to circumstances which may arise, without in any way departing from the spirit and intention of the present invention, which is to be limited only in accordance with the claims contained herein.

### DETAILED DESCRIPTION OF AT LEAST ONE EMBODIMENT OF THE INVENTION

In general, liquid HVAC coil cleaners contain certain primary components to be effective. More specifically, liquid HVAC coil cleaners generally contain a metal-reactive component such as an acid or alkaline ingredient, a surfactant, a chelating agent, a thickening agent (optional), and a foam builder/stabilizer (optional). Those of skill in the art will be familiar with each of these components.

The metal-reactive component is used to release the binding that debris build-up may have on the metal surfaces of the HVAC coil. It is used to loosen the debris so that the debris can then be manipulated by other components of the HVAC coil cleaner. Common acidic metal-reactive ingredients include some form of hydrofluoric acid or ammonium biflouride (ammonium hydrogendifluoride). Common alkaline metal-reactive agents include some forms of sodium hydroxide (also known as “caustic soda”) or potassium hydroxide (also known as “potash”). Typical metal-reactive components, as well as examples of other chemical components suggested or identified herein, can be found by reference to U.S. Pat. No. 7,338,564 and U.S. Published Patent Application number 2007/0281876.

A surfactant is generally any material that is used to dissolve dirt in a manner that allows water and detergent to penetrate between the dirt and a metal surface. This is to say, surfactants can act as a release agent for the dirt and debris that may be found within the HVAC coil. A specific surfactant is usually chosen for HVAC coil cleaners based upon its detergency and foaming ability. Surfactants having high foaming characteristics are generally preferred. Nevertheless, in certain applications, low foaming detergents may also be used while remaining within the intended scope of the present invention. Detergents that produce long-lasting and durable foams are also preferred. While the primary goal in the selection and use of a surfactant is detergency and degreasing ability, dispersant characteristics are also desirable. Preferred surfactants form bubbles that encapsulate the dirt within the HVAC coil and allow the loosened dirt to be washed away from the coil.

There are a number of various categories of surfactants, but the most common categories of surfactants used in HVAC coil cleaners are anionic, cationic, and non-ionic. Dry surfactants are available in those types, however, there are a larger number of liquid surfactants and liquid surfactants are normally less costly. As a result, in many HVAC coil cleaners, liquid surfactants are used.

Chelating agents are chemical compounds used to remove either metal or minerals from the HVAC coil and then keep them in solution to inhibit redeposit of the removed metal and minerals back onto the metal surface of the HVAC coil. Examples of such debris are similar to hard water deposits and lime stains that can build up on residential faucets. Those types of mineral deposits are easier to wash away from the HVAC coil if they can be held in suspension in the solutions. Chelating agents can be included in the HVAC coil cleaner for that purpose.

Thus, the surfactant is generally used to encapsulate and loosen the oil-based deposits from the surface to be cleaned, and the chelating agent encapsulates and loosens other things like mineral from the surface to be cleaned. Together, the surfactant and the chelating agent can act to make the foreign contaminates soluble to make such contaminates easier to remove from the HVAC coil.

The thickening agent in HVAC coil cleaners is sometimes used to increase the general overall performance of the coil cleaner. When used, the thickening agent can improve the ability of the cleaner to cling better to vertical surfaces that are being cleaned. It is noted that the incorporation of a thickening agent into the HVAC coil cleaner is optional because increasing the surfactant percentage of composition can generally achieve the same result without the use of a thickening agent.

An alternative method of increasing the ability of the HVAC coil cleaner to cling to vertical surfaces is to include a foaming agent or foaming stabilizer in the HVAC coil cleaner. The foaming/stabilizing agent acts to increase the formation of bubbles in the surfactant and this increase adds to the ability of the surfactant to cling to vertical surfaces. As was the case for the thickening agents, a foaming/stabilizing agent is an optional ingredient in the HVAC coil cleaners.

It is understood that there are a large number of embodiments of the present invention. Each embodiment can be tailored as needed to provide the best performance as needed and dictated by the specific application for which the liquid HVAC coil cleaner will be used. Nevertheless, it has been found that most preferred embodiments have certain chemical combinations and ranges of percentages of composition for each of the two components of the two-part liquid HVAC cleaner system. The following provides a preferred set of such combinations and certain rules for the combinations as found during the extensive testing and research conducted to successfully ascertain the elements of various embodiments of the present invention.

More specifically, one preferred embodiment is an alkaline-based version of the two-part liquid HVAC cleaner system. In that embodiment, the first set of chemical components 1 comprises a surfactant between about 15% to about 20% of composition, a thickening agent at between about 5% to about 15% of composition, a foam builder/stabilizer at between about 20% to about 30% of composition, with water being the final component as necessary to complete the total percentage of composition. In that same embodiment, the second set of chemical components 2 comprises a caustic soda at between about 90 to about 95% of composition and a chelate at between about 5 and about 10% of composition.

A second preferred embodiment of the present invention is an acidic-based version. In that embodiment, the first set of chemical components 1 comprises ammonium biflouride at between about 20% and about 50% of composition, a surfactant at between about 8% to about 10% of composition, a thickening agent at between about 10% and about 30% of composition, a chelate at between about 5% and about 10% of composition, with water being the final component as necessary to complete the total percentage of composition. In this same second embodiment, the second set of chemical components 2 comprises a generic acid at between 10% and about 75% of composition water being the final component as necessary to complete the total percentage of composition. Suggested generic acids include phosphoric, hydrochloric, or sulfuric acids. In each of the first and second embodiments noted, a minimum amount of water s used. This is to say, the water in one of either the first set of chemical components 1 or the second set of chemical components 2 shall be only an amount as needed to keep the first and set of chemical components in stable liquid form.

It is noted that one function of combining the ammonium biflouride with the generic acid is to generate hydrofluoric acid from the acid combination. Those of skill in the art are well aware that hydrofluoric acid is an extremely dangerous chemical that can cause severe injury or death if it comes into contact with human skin. It is also noted that hydrofluoric acid is also a desirable chemical component for inclusion in a high performing HVAC coil cleaner. Thus, by not shipping the hydrofluoric acid in its hazardous form, but instead including two chemicals that when combined can react to generate the hydrofluoric acid at the job site after shipping, the safety index is significantly increased and the cost of shipping two reduced hazard chemicals rather than one extremely hazardous chemical also significantly reduces the cost of packaging and shipping.

It is also noted that the identification of which components are within the first set of chemical components 1 the second set of chemical components 2 are not a specific requirement of the present invention, but simply disclose one preferred embodiment of the invention. For example, certain other combinations of the required chemicals can be combined in the first set of chemical components 1 the second set of chemical components 2 as long as certain rules of combination are met. As long as the disclosed chemicals are used within the noted ranges of percentages of composition, it is intended that each embodiment that uses different acceptable combinations of those chemicals is included within the scope of the present invention.

As with the chemical combinations and percentages of compositions noted in the above embodiments, the rules of chemical combination were either found or verified through the extensive research and experimentation conducted to generate the present invention. These general rules include that fact that; (1) the surfactant can be in either the first set of chemical components 1 or the second set of chemical components 2; (2) the thickener cannot be combined with the caustic soda because it can generate a precipitate or a gelatinous non-soluble mixture, and the caustic soda can decompose the surfactant; (4) the foam builder/stabilizer cannot be combined with the caustic soda because the caustic soda will decompose the foam builder/stabilizer; (5) the chelate can be within the first set of chemical components 1 or the second set of chemical components 2; (6) the ph factor of the combination of the surfactant, the foam builder, and the thickener that may be included in either the first set of chemical components 1 or the second set of chemical components 2 should be maintained at a ph level of between about 6 and about 9 to allow the components in that part to be soluble; (7) the generic acid must not be combined with the ammonium biflouride because as soon as those two chemicals are combined, the result includes hydrofluoric acid—a very hazardous material; (8) otherwise the remaining chemical ingredients and specific percentages of composition may be mixed in either the first set of chemical components 1 or the second set of chemical components 2 in any combination.

Regardless of the embodiment of the present invention, it will be appreciated by those of skill in the art that the chemical components noted above can be varied within the noted ranges as needed to meet the requirements for specific applications. For example, considerations related to viscosity, stability, solubility, portability, efficacy, and safety can be used to determine the exact percentage of composition of each chemical component as those exact percentages fall within the general ranges as noted above.

Certain performance factors can also determine the exact percentages within the specified ranges of composition. Some such performance factors include, for example, improved solubility and stability. If solubility is a factor, the user may wish to pick a surfactant that is either more or less soluble and in that case the percentages of the surfactant and the other chemical components can be adjusted to enhance solubility under well-known chemical properties known in the art. If stability is a concern, the user may wish to select a chelate that is more stable and in that case the percentages would need to be changed to enhance stability under well-known chemical properties known in the art. In any such case, as long as the percentages of composition remain with the ranges specified above, each such adjusted combination is still intended to be within the scope of the present invention.

Referring now to the drawings, at least one preferred embodiment of the present invention of a two-part liquid HVAC coil cleaner system A is illustrated in FIG. 1. In this embodiment, the two-part liquid HVAC coil cleaner system A comprises a first set of chemical components 1 and a second set of chemical components 2 that are individually stored in separate compartments 3 and 4 of a container 5. Each of the two compartments 3 and 4 have an individual opening 6 and 7 that makes use of leak resistant caps 8 to retain the first set of chemical components 1 and the second set of chemical components 2 within their separate compartments 3 and 4. Various labels (not shown) are placed upon the container 5 that describe the general contents of the container and the instructions regarding the combination of the first set of chemical components 1 with the second set of chemical components 2, and a certain amount of water to prepare a liquid HVAC coil cleaner 9. It will be appreciated that the mixing process usually includes pouring the first set of chemical components 1 and the second set of chemical components 2 into a pail 10. It is understood that the required amount of water can be in the pail 10 before or after the addition of the first set of chemical components 1 and the second set of chemical components 2 into the pail. It is also understood that while certain preferred embodiments may include using the pail 10 for the mixing of the two sets of chemical components, other embodiments allow the use of other containers such as sprayers and sprayer bottles instead of the pail and still remain within the scope of the present invention.

The container 5 and the two compartments 3 and 4 can be made from any chemically inert material that does not chemically react with any of the components or combinations of chemical components of either of the first set of chemical components 1 or the second set of chemical components 2. It is noted that while the present embodiment discloses a single container 5 that incorporates the two segregated compartments 3 and 4 to result in a single integrated container, yet other embodiments of the present invention can comprise two separate containers with either of the two separate containers can contain one of the first set of chemical components 1 or the second set of chemical components 2.

When the two-part liquid HVAC cleaner has been properly mixed with the correct amount of water at the job site, the resultant cleaning solution is used to clean the surfaces of the HVAC coil. This cleaning process generally begins with spraying the liquid cleaner onto the entire coil and allowing time for the cleaner to generate foam on the surfaces of the coil. The metal-reactive component and the surfactant component of the cleaner combine to generate foam which dissolves the dirt and debris on the coil and then tend to force the dirt away from the inside of the coil to the outside of the coil. It is understood that the foam generates a physical mechanical pressure that generally lifts the foam that contains the dissolved dirt and debris from the surfaces of the coil. The foaming process usually requires about 5-10 minutes. The foam is rinsed off the coil to stop the corrosive action of the cleaner on the coil. Because the cleaner dissolves and lifts contaminants from the surfaces of the coil, there is generally no need for vigorous brushing action.

It is noted that the compartments 3 and 4 of container 5 show that one compartment is larger than the other compartment. The difference in the size of the two compartments is not an indication of the amount of either the first set of chemical components 1 or the second set of chemical components 2 are required for the present invention. Instead, the sizes of the two compartments 3 and 4 depict only one embodiment of the present invention and are shown for exemplary purposes only. Thus, it is understood that the sizes of each of the compartments 3 and 4 can be adjusted as needed to match the volume of the first set of chemical, components 1 and the second set of chemical components 2 as determined by the specific embodiments of the present invention as necessary for each application.

While the above description describes various embodiments of the present invention, it will be clear that the present invention may be otherwise easily adapted to fit any configuration where a liquid HVAC cleaning system is required. Additionally, as various changes could be made in the above constructions without departing from the scope of the invention, it is also intended that all matter contained in the above description or shown in the accompanying drawings shall be interpreted as illustrative and not in a limiting sense. The scope of the invention should be determined by the appended claims and their legal equivalents, rather than by the examples given.

1. A cleaning system for cleaning HVAC coils comprising:
a container having a first compartment and a second compartment;
a first set of chemical components placed inside the first compartment wherein the first set of chemical components contain chemical components that constitute part of the chemicals needed to generate a liquid cleaning agent for cleaning HVAC coils;
a second set of chemical components placed inside the second compartment wherein the first set of chemical components and the second set of chemical components are in liquid form, wherein the first set of chemical components comprises a surfactant, a thickening agent, a foam builder/stabilizer, and a sufficient amount of water, wherein the second set of chemical components comprises a caustic soda and a chelate, and wherein combining the first set of chemical components and the second set of chemical components with a sufficient amount of water results in one of either an alkaline-based or an acidic-based liquid cleaning agent for cleaning HVAC coils.

2. (canceled)

3. (canceled)

4. (canceled)

5. The cleaning system of claim 1 wherein the amount of the surfactant is between about 15% to about 20% of composition of the first set of chemical components.

6. The cleaning system of claim 1 wherein the amount of the thickening agent is between about 5% to about 15% of composition of the first set of chemical components.

7. The cleaning system of claim 1 wherein the amount of the foam builder/stabilizer is between about 20% to about 30% of composition of the first set of chemical components.

8. The cleaning system of claim 1 wherein the caustic soda is about a 50% solution that is between about 90% and about 95% of the total composition of the second set of chemical components.

9. The cleaning system of claim 1 wherein the amount of the chelate is between about 5% and about 10% of the composition of the second set of chemical components.

10. The cleaning system of claim 1 wherein the first set of chemical components comprises a surfactant between about 15% to about 20% of composition, a thickening agent at between about 5% to about 15% of composition, a foam builder/stabilizer at between about 20% to about 30% of composition, and a sufficient amount of water as necessary to complete the total percentage of composition.

11. The cleaning system of claim 1 wherein the second set of chemical components comprises about a 50% solution of caustic soda that is between about 90% and about 95% of the total composition of the second set of chemical components and a chelate at between about 5% and about 10% of composition.

12. The cleaning system of claim 1 wherein the first set of chemical components comprises ammonium biflouride, a surfactant, a thickening agent, a chelate, and a sufficient amount of water.

13. The cleaning system of claim 12 wherein the second set of chemical components comprises a generic acid and a sufficient amount of water.

14. The cleaning system of claim 13 wherein the amount of the ammonium biflouride is between about 20% and about 50% of composition of the first set of chemical components.

15. The cleaning system of claim 13 wherein the amount of the surfactant is between about 8% to about 10% of composition of the first set of chemical components.

16. The cleaning system of claim 13 wherein the amount of the thickening agent is between about 10% and about 30% of composition of the first set of chemical components.

17. The cleaning system of claim 13 wherein the amount of the chelate is between about 5% and about 10% of composition of the first set of chemical components.

18. The cleaning system of claim 13 wherein the amount of the generic acid at between 10% and about 75% of composition of the first set of chemical components.

19. The cleaning system of claim 13 wherein the first set of chemical components comprises ammonium biflouride at between about 20% and about 50% of composition, a surfactant at between about 8% to about 10% of composition, a thickening agent at between about 10% and about 30% of composition, a chelate at between about 5% and about 10% of composition, and a sufficient amount of water as necessary to complete the total percentage of composition.

20. The cleaning system of claim 19 wherein the second set of chemical components comprises a generic acid at between 10% and about 75% of composition and a sufficient amount of water as necessary to complete the total percentage of composition.
